(19) United States
(12) Patent Application Publication
(10) Pub. No.: US 2006/0118051 A1
(43) Pub. Date: Jun. 8, 2006

(54) Fold up pet bed

(75) Inventor: Frank Lima, (US)

Correspondence Address: Joseph L. Strabala, Esq.;Law Office of Joseph L. Strabala, Suite1020, One Embarcadero Center, San Francisco, CA, 94111, US

(73) Assignee: Midnigth Pass, Inc. a Nevada Corporaiton

(21) Appl. No.: 11/252,822

(22) Filed: Oct. 18, 2005

Related U.S. Application Data
(60) Provisional application No. 60/632,805, filed on Dec. 3, 2004.

(51) Int. Cl. A01K 29/00

(52) U.S. Cl. 119/28.5

(57) ABSTRACT

The novel fold up pet bed includes a vertical hollow rectangular box with an opening therein, a rectangular bed component having one end hinged in the box so the other end of the bed component can be moved about the hinge to open and close the opening in the box, a replaceable pad in disposed on the bed component and a support hinged on the distal end of the bed component operable to keep bed component elevated above the floor when the bed is opened and to lie in the plane of the bed component when it is closed so the inside surface of the support will abut against the box to fully close the opening. Decorative panels attached to the bed component have a periphery larger than the bed component and operable to overlap the edges of the box to create finished look.

This application is a continuation of Provisional Patent Application Ser. No. 60/632,805 filed on Oct. 29, 2004 which application is incorporated herein by reference.

The current invention relates to pet beds which can be folded in a manner to reduce floor space occupied by the bed when not in use and which will give the appearance of typical furniture when closed masking its principal use.

Numerous pet beds are on the market, some of which can be collapsed for transport. The current invention, by distinction, is designed to fold the bed for the pet into a vertical box like container by hinging one end of the bed in the container and lifting the other end so that it folds into the box. Somewhat similar devices for humans are known as Murphy beds, see U.S. Pat. Nos. 6,425,15; 5,033,134; 4,793;011; and 4,694,528. In addition pet beds of this type can be found on the internet, at various sites, such as www.wallbedsbywilding.com/dogbeds.html.

Other devices, such the device shown in U.S. Pat. No. 3,618,568, employs a drawer containing a pet bed which can be with drawn from its case when the pet bed is in use and stored in the case when it is not in use.

An object of the current invention is to provide a pet bed, when not in use, can be folded into an attractive piece of furniture to reduce the amount of floor space consumed by the bed, especially in confined areas, such as in apartments and the like.

A further object of the current invention is the provision of a support system that keeps the finished under surface of the bed from contacting the floor when the bed is opened.

Another object is to provide a stylish alterative to conventional pet beds which add clutter to a room when left in the open.

Other objects will be apparent from the drawings and the following specification.

### SUMMARY OF THE INVENTION

The novel fold up pet bed includes a vertical hollow rectangular box with an opening therein having its exterior configured to look like a typical piece of furniture, a rectangular bed component having one end hinged in the box so the other end of the bed component can be moved about the hinge to open and close the opening in the box, a replaceable pad is disposed in the bed component so that when the box is closed, the pad will be in the hollow space between box and the bed component, and a support hinged on the distal end of the bed component operable to keep bed component elevated when the bed component is opened and to lie in the plane of the bed component when the bed component is closed so its inside surface will abut against the box.

The outer surface of the bed component is finished in a manner compatible with the exterior of the box so that when closed, such as by attaching panels thereto, so it will complement the furniture configuration. Further since bed component is elevated when the bed open its exterior surface can include paneling, projecting knobs, handles and the like. Moreover the top of the rectangular box can include a storage compartment in its top for pet toys and the like.

### DESCRIPTION OF THE DRAWINGS

FIG. 1 is a perspective of the novel fold up pet bed with the bed in the folded position;

FIG. 2 is a front view of the novel pet bed shown in FIG. 1 with the bed in the folded position;

FIG. 3 is an elevation of the novel pet bed shown in FIG. 1 with the bed in the folded position;

FIG. 4 is a perspective of the novel pet bed with bed in the open position illustrating the support panel on the distal end of the bed component;

FIG. 5 is an sectional view of the novel pet bed with its bed in the closed position;

FIG. 6 is a sectional view of the novel pet bed with the bed in the open position with the top or lid for the compartment partially opened and phantom lines illustrating the manner in which the bed component is folded;

FIG. 7 is a broken away sectional view, with parts broken away, illustrating the recessed hinge connection of the bed component with its vertical housing;

FIG. 8 is a broken away sectional view illustrating the recessed hinge connection of the support on the distal end of the bed component and a magnetic latch for the support when the bed in the open position; and

FIG. 9, also a sectional view, with parts broken away, illustrates a latch system for retaining the bed component in the closed position.

### DESCRIPTION OF AN EMBODIMENT OF THE PET BED

Referring to FIGS. 1, 2 and 3 the exterior of the novel pet bed 10 can be seen. It includes a vertical rectangular box member 11 that includes top 12 which is hinged on the back 13 of this member with hinge 14 so the top can be lifted to access a storage compartment 15 for pet toys and the like formed by a transverse panel 16 spaced just below the inside surface of the top, as is shown in FIGS. 5 and 6. In the base of the box member legs 17 and 18 support its bottom 19 so it is elevated above the floor on which box member is positioned.

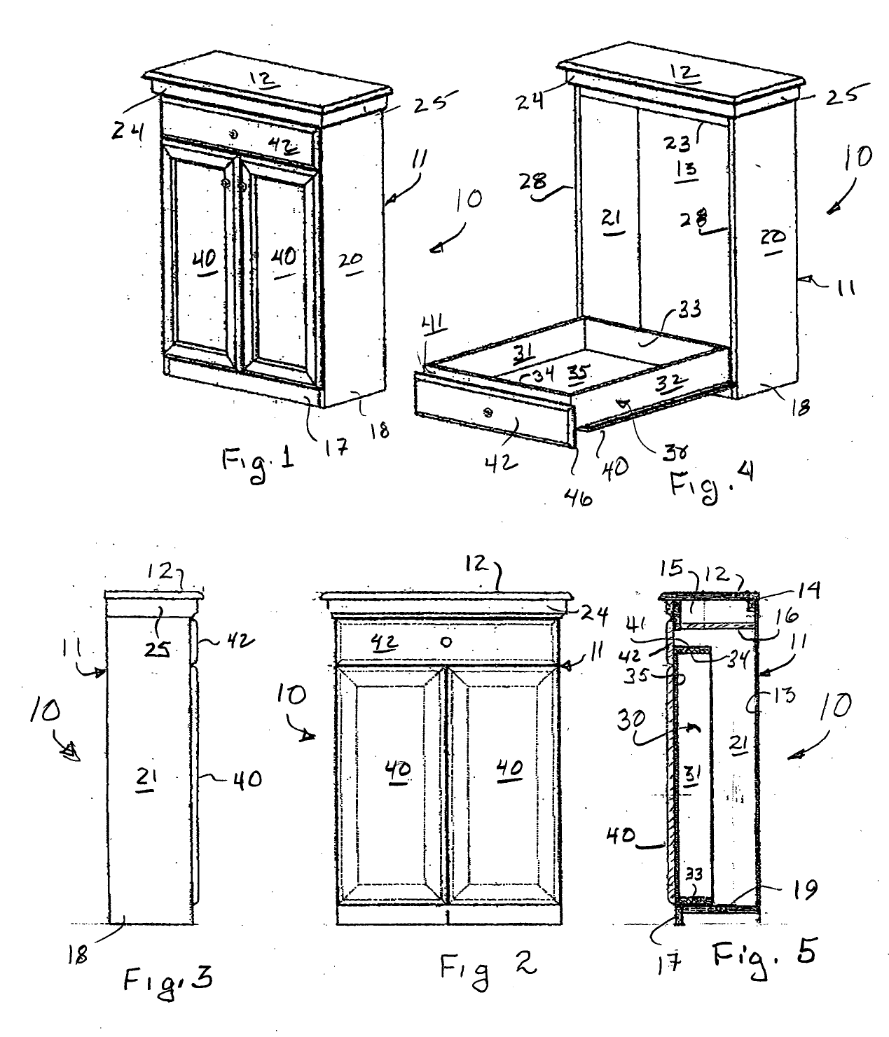

Vertical panels 20 and 21 form the sides of the box member 11 and extend below the horizontal plane of its bottom 19 to form legs 18 on both sides of the box member. The back or panel 13 closes one face of the box member leaving the other open, opening 22. A fascia panel 23 closes a portion of this opening at its top, as can be seen in FIGS. 4, 5 and 6 and cooperates with the transverse panel 16 to form compartment 15 in the top of the box member. To give a box member a finish look, molding 24 and 25 are respectively secured to the fascia panel and the tops of the side panels 20 and 21 of the box member.

The bed component 30, shown in FIGS. 5 and 6, is typically a second open rectangular box that is designed to closely fit in the opening 22 of the box member 11, leaving a gap just below transverse panel 16 when received in the opening. This gap allows the distal end of the bed component to pass through the opening.

Bed component 30 typically includes two side panels 31 and 32 and two ends panels 33 and 34 and a bottom 35 connected to these panels, which together form an open box structure for the bed. A pet mattress or the like (not shown) is placed in this box when in use and the bottom may include hooks or velcro strips (not shown) to secure the mattress in this box.

The outer face end panel 33 of the bed component 30 is connected to the inside surface of the bottom 19 of box member 11 with an elongated hinge 36, such a piano hinge, as can be seen in FIG. 7. Using recesses enables outer face of end panel 33 to rest on the top surface of the bottom 19 when the bed component is closed or folded up without leaving gaps, as shown in FIG. 6. When the bed component is closed its bottom surface 38 is flush with the edges 28 of the vertical panels or sides 20 and 21 of the box member

Since the bottom 38 of the bed component 30 is flush with edges 28 of the box member 11, decorative panels 40 can be secured to the bottom of the bed component so that panels overlap the edges of the box member to give the unit a finished look when the bed component is in opening 22 of the box member, as can be seen in FIG. 2.

Since the base 19 of the box member 11 is elevated by legs 17 and 18 the distal the end 41 of the bed component 30 must be supported to keep this component level. The required support is supplied by a novel false drawer front 42 which is connected to the bottom 38 of the bed component with a recessed hinge 43 as best shown in FIG. 8. Typically a recessed metal plate 44 is counter sunk on the inside surface of the drawer front and a cooperative magnet 45 is place in end panel 34 so that the magnet will temporarily retain the false drawer front against end panel 34 when the bed is open. The hinge is centrally located on the inside surface of the drawer front so a portion thereof will extend below bottom forming a temporary leg 46 on the distal end of the bed component, as can be seen in the drawings.

When the bed component 30 is closed, the temporary leg 46 must be stowed. This is accomplished by articulating the drawer front 42 about hinge 43 so that part of its inside surface abuts against the bottom 38 of the bed component and so that it aligns with the decorative panels 40 (lies in the same plane). Because of the central location of hinge 43 part of false drawer front 42 will extend above the distal end 41 of the bed component when its stowed. As a result the a top portion of the inside surface of the drawer front will abut against the outer surface of the fascia panel 23 to completely close the opening 22 (the top gap) in the box member, see FIG. 5.

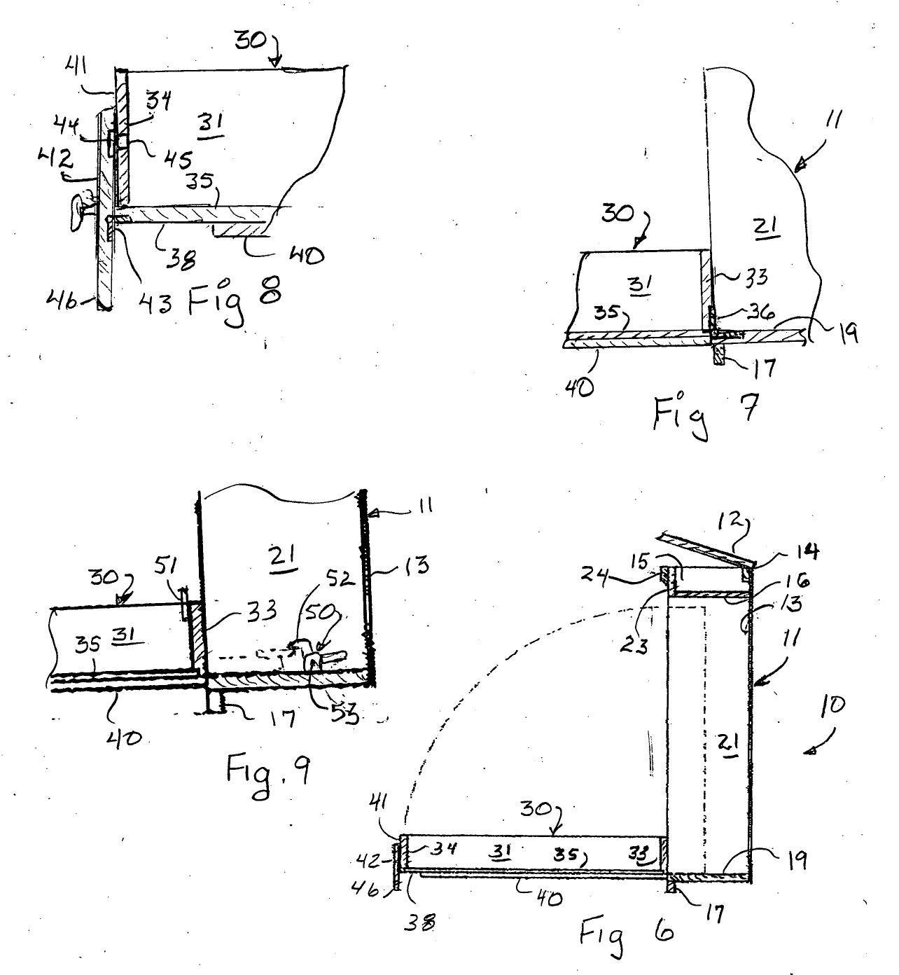

Various means can be used to secure the bed component 30 in its folded or closed position. In FIG. 9 a simple catch 50 is illustrated which cooperates with a latch plate 51 secured to the end panel 33 of the bed component. When the bed component is closed the latch plate will be engaged by hook 52 locking the bed component in the closed position. An extension (not shown) of the pivot 53 for controlling the hook can be extended through one of the side panels and rotated to release the hook when the bed is opened. Other types of catches or latches can be employed, such as friction catches that need no release mechanisms.

Because the exterior surfaces of the decorative panel 40 and the drawer front 42 do not rest on the floor when the bed is in use, their finishes will not be scratched and can include projecting knobs and handles to better disguise the pet bed as traditional furniture.

Having described my invention I claim:

1. A fold up pet bed comprising:
a rectangular box means having an opening and means to support it in a vertical position;
a rectangular bed component means having one end hinged in such opening operable to open and close such opening in said box means, said bed component means having a pad secured thereto; and
a support member hinged on the on the distal end of said bed component means operable to form a support for such end when said bed component is horizontal and to fold to a planer position with said bed component means when the latter closes such opening in said box means so that the inside surface of said support member abuts on the exterior of said box means to completely close such opening.

2. The fold up pet bed described in claim 1 wherein the top of the box means includes a compartment for storing items and the top of said box means is hinged thereon so such compartment can be accessed.

3. The fold up pet bed described in claim 1 wherein the bed component means includes at least one panel secured to its outer surface, said panel having a periphery larger than said bed component so that its periphery overlaps the edges of the box member means when said bed component is closed into said box means.

4. The fold up pet bed described in claim 1 wherein the bed component is a rectangular box operable to fit into the box means and includes a mattress for a pet within said rectangular box.

5. The fold up pet bed described in claim 1 wherein the box means includes latch means cooperating with the bed component means operable to secure said bed component in box means when said bed component means closes the opening of said box means.

6. The fold up pet bed described in claim 1 wherein the support member is a false drawer front hinged to the distal end of the bed component means.
